(19) United States
(12) Patent Application Publication
(10) Pub. No.: US 2015/0022100 A1
(43) Pub. Date: Jan. 22, 2015

(54) LED driving device and control method

(71) Applicants: Hong Zhang, Suzhou (CN); Xiaobin Gu, Suzhou (CN); Xiaoming Wu, Suzhou (CN); Laijian Chen, Suzhou (CN); Wei Cheng, Suzhou (CN); Hanniu Gong, Suzhou (CN)

(72) Inventors: Hong Zhang, Suzhou (CN); Xiaobin Gu, Suzhou (CN); Xiaoming Wu, Suzhou (CN); Laijian Chen, Suzhou (CN); Wei Cheng, Suzhou (CN); Hanniu Gong, Suzhou (CN)

(21) Appl. No.: 13/811,907

(22) PCT Filed: Mar. 30, 2012
(86) PCT No.: PCT/CN12/00415

§ 371 Date: Jan. 24, 2013

(30) Foreign Application Priority Data
Mar. 2, 2012 (CN) 201210054050.9

(51) Int. Cl. H05B 33/08

(52) U.S. Cl. CPC H05B 33/0815; H05B 33/083; H05B 33/0851
USPC 315/186; 315/206; 315/205

(57) ABSTRACT

The invention is provided with an LED driving device and the control method. The driving device includes power converter, microprocessor and LED circuit. Wherein the power converter includes impulse transformer and switch control circuit. Primary winding at input side of the impulse transformer connects with rectifier filter circuit by the switch control circuit. Secondary winding at output side and auxiliary winding connect with power end of the microprocessor by constant voltage control switch. Output end of the microprocessor connects with LED circuit. The LED driving device and the control method provided by this invention collects on/off signal of mechanical lamp by using switch control circuit. Light is adjusted by LED circuit driven by the microprocessor, and thus heat elimination effect is improved, power consumption is lowered and brightness is enhanced.

### BACKGROUND OF THE INVENTION

1. Field of the Invention

The invention relates to a driving circuit and its control method and more particularly to an LED driving device and its control method.

2. Description of Related Art

LED (Light Emitting Diode) is a solid semi-conductor component that can directly convert electricity into light. Core of LED is a semi-conductor chip. One end of the chip is attached to a bracket, one end is negative pole, and the other end is connected with positive pole of power supply. Hole takes a dominant position in it. The other end is N-shaped semi-conductor with mainly electronics in it. When the two kinds of semi-conductor are connected together, they form a P-N knot. When current functioning on the chip with wire, electronics will be pushed to area P. In area P, electronics will recombine with the hole, and then transmit energy in form of photon, and this is the principle of LED light emitting. Wavelength of light (meaning color of the light) depends on the material forming P-N knot.

Most of the LED driving devices at current market are troubled with insufficient brightness, extremely high power, poor heat elimination effect, fast light attenuation and high cost. Therefore, it is necessary to improve LED driving device and its control method for lowering power consumption and enhancing brightness.

Thus, the need for improvement still exists.

### SUMMARY OF THE INVENTION

The technical problem to be solved by this invention is to provide an LED driving device and its control method capable to improve heat elimination effect, lowering power consumption and enhance brightness.

Technical solution adopted to solve the technical problems above by this invention is to provide an LED driving device, comprising power converter, microprocessor and LED circuit. Wherein, the power converter comprises impulse transformer and switch control circuit. Primary winding at input side of the impulse transformer connects with rectifier filter circuit by the switch control circuit; secondary winding at output side and auxiliary winding connect with power end of the microprocessor by constant voltage control switch. Output end of the microprocessor connects with LED circuit.

In the LED driving device, the rectifier filter circuit comprises preceding capacitor CX1, rectifier bridge BD1 and primary π-shaped filter circuit. The π-shaped filter circuit is composed of capacitor C1, capacitor C2 and inductance L1.

In the LED driving device, the switch control circuit comprises main control switch frequency chip. Drain electrode end D of the main control switch frequency chip connects with surge absorber circuit. The surge absorber circuit is composed of capacitor C3, resistance R4 and diode D4. Two ends of the surge absorber connect with two ends of the impulse transformer and primary winding.

In the LED driving device, the constant voltage control circuit is composed of stabilivolt output circuit and auxiliary voltage control circuit; positive pole of the stabilivolt output circuit Vo+ connects with one end of the secondary winding by inductance L3, rectifier D6 and impulse transformer, while the negative pole Vo− connects with the other end of secondary winding of the impulse transformer; two ends of the rectifier D6 connects with filter circuit composed of resistance R6 and capacitor C8 by parallel connection. Two ends of inductance L3 connects with the other end of the secondary winding by output filter capacitor C6 and C7; output end of the rectifier D6 connects with output end of optical couple U2 by constant voltage stabilivolt VR2 and testing resistance R7. Input end U2 of the optical coupler connects with output end FB of the main control switch frequency chip. The auxiliary voltage control circuit is composed of diode D5, capacitor C4 and resistance R5. Two ends of the auxiliary winding of the diode D5, capacitor C4 impulse transformer connect together to form a loop. One end of the capacitor C4 connects with bypass BP of the main control switch frequency chip by resistance R5, and the other end is for grounding; the bypass BP of the main control switch frequency chip is in ground connection by capacitor C5.

In the LED driving device, power end Vcc of the microprocessor connects with positive pole Vo+ of the stabilivolt output circuit by three-terminal stabilizer permitting connection with stabilivolt output circuit by impulse level judging circuit. The impulse level judging circuit is composed of diode D1, resistance R1 and R2. The diode D1 connects with resistance R1 in serial after connecting with resistance R2 in parallel.

In the LED driving device, output end of the microprocessor connects with LED circuit by the constant voltage control circuit composed of various groups of twin triode, and each group of the constant control circuit drives an LED circuit.

In the LED driving device, the LED circuit comprises three lines of LED strip including CL1, CL2 and CL3. Each line of LED strip is composed of various LED strips connected in parallel and serial.

To solve the technical problems above, this invention provides a control method of LED driving device, comprising the following steps: a) Power converter collects on/off signal of the mechanical switch control lamp; b) Microprocessor receives on/off signal from the power converter, and outputs control signal to perform on/off control on LED circuit.

In control method of the LED driving device above, one interval between “On” and “Off” of the on/off signal is 0.1-6 second(s). The microprocessor receives on/off signal from the power converter by impulse level judging circuit. The impulse level judging circuit is composed of diode D1, resistance R1 and R2. The diode D1 and resistance R2 connect with resistance R1 in serial after being connected in parallel.

The invention enjoys the following beneficial effects comparing with the existing technologies: The LED driving device and the control method provided by this invention collects on/off signal of mechanical lamp by using switch control circuit. Light is adjusted by LED circuit driven by the microprocessor, and thus heat elimination effect is improved, power consumption is lowered and brightness is enhanced. By this way, better heat elimination effect, lower power consumption and higher brightness are achieved.

The above and other objects, features and advantages of the invention will become apparent from the following detailed description taken with the accompanying drawings.

### BRIEF DESCRIPTION OF THE DRAWINGS

FIG. 1 is a schematic diagram of LED driving device circuit of this invention;

FIG. 2 is a schematic diagram of power converter circuit in the LED driving device of this invention;

FIG. 3 is a schematic diagram of microprocessor circuit in the LED driving device of this invention; and

FIG. 4 is a schematic diagram of LED circuit on the LED driving device of this invention.

### DETAILED DESCRIPTION OF THE INVENTION

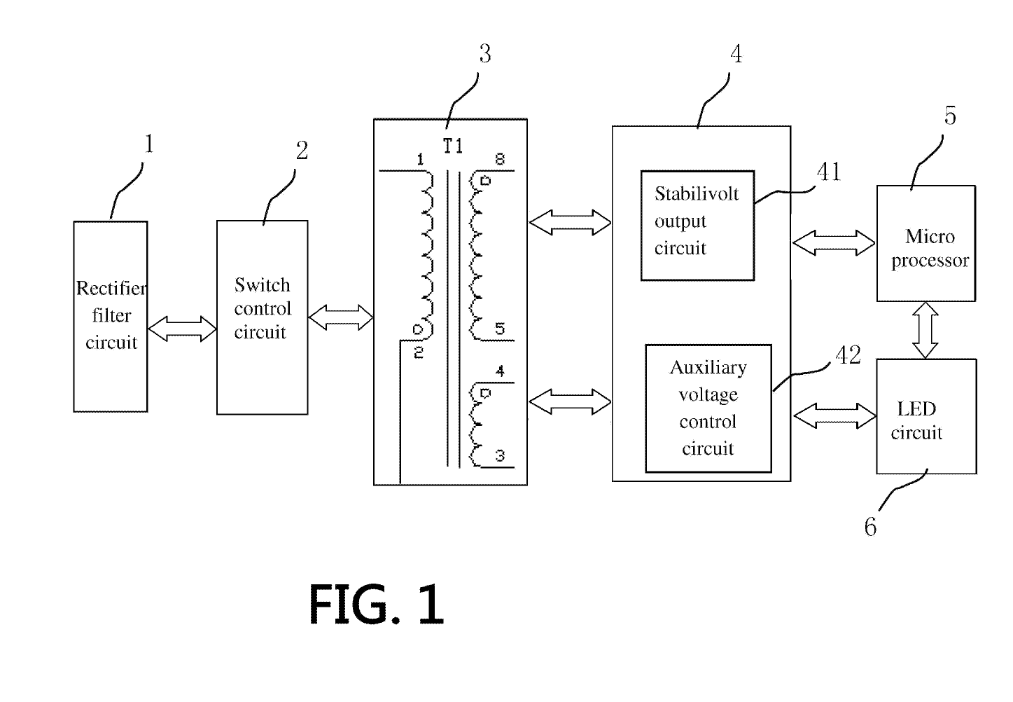

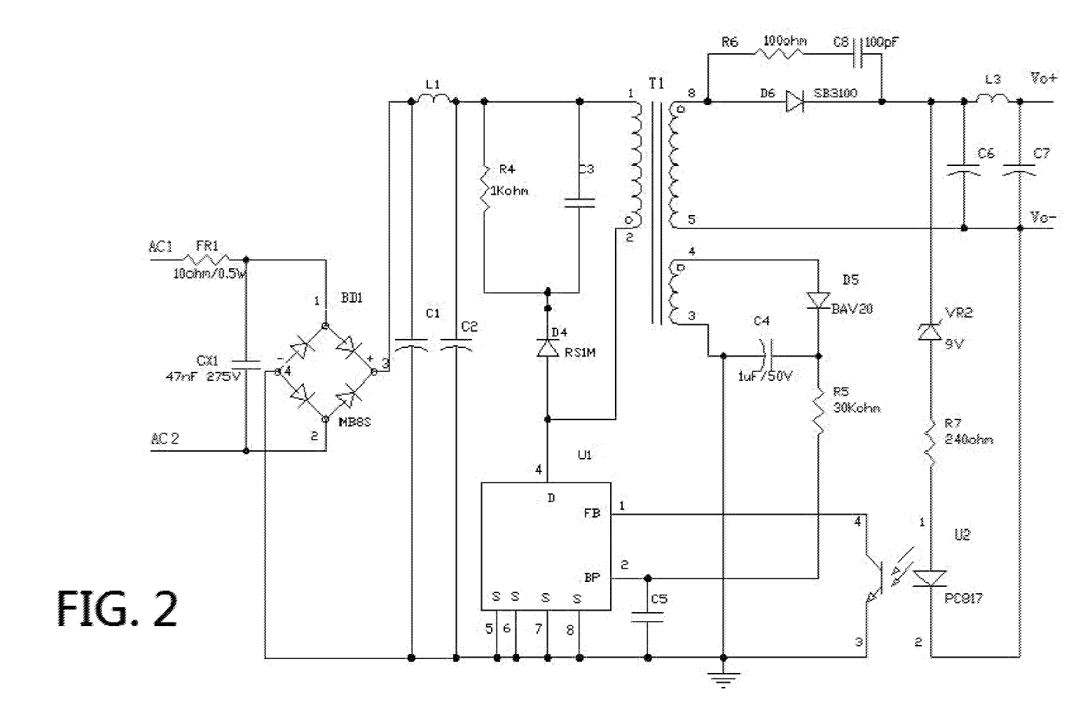

Referring to FIGS. 1 and 2, an LED driving device provided by this invention comprises power converter, microprocessor 5 and LED circuit 6. In the device, power end of the microprocessor 5 connects with the power converter, the output end connects with LED circuit 6. The power converter compromises impulse transformer 3 and switch control circuit 2. Primary winding at input side of the impulse transformer 3 connects with rectifier filter circuit 1 by the switch control circuit 2; secondary winding at output side and auxiliary winding connect with LED circuit 6 by constant voltage control circuit 4. The power converter inputs 220V AC, and outputs 4-20V DC after conversion with the transformer, and converts to voltage and current needed for operating of LED circuit 6 and microprocessor 5. High frequency switch control circuit 2 can connect with microprocessor 5 to realize power on/off the lamp (within 5 seconds for one interval between “On” and “Off”), to change LED light brightness. Microprocessor 5 can be set to 1-section light control or N-section (sectional digits for lamp brightness) control.

TNY serial chips from PI Company can be selected for the main control switch frequency chip in the switch control circuit 2, e.g., TNY278PN, TNY279PN. The chips include source S, enable EN, bypass BP and drain electrode D, as shown in FIG. 2; the drain electrode D of the main control switch frequency chip connects with circuit of surge absorber. The surge absorber circuit is composed of capacitor C3, resistance R4 and diode D4. Two ends of the surge absorber circuit connect with the two ends of primary secondary winding of the impulse transformer.

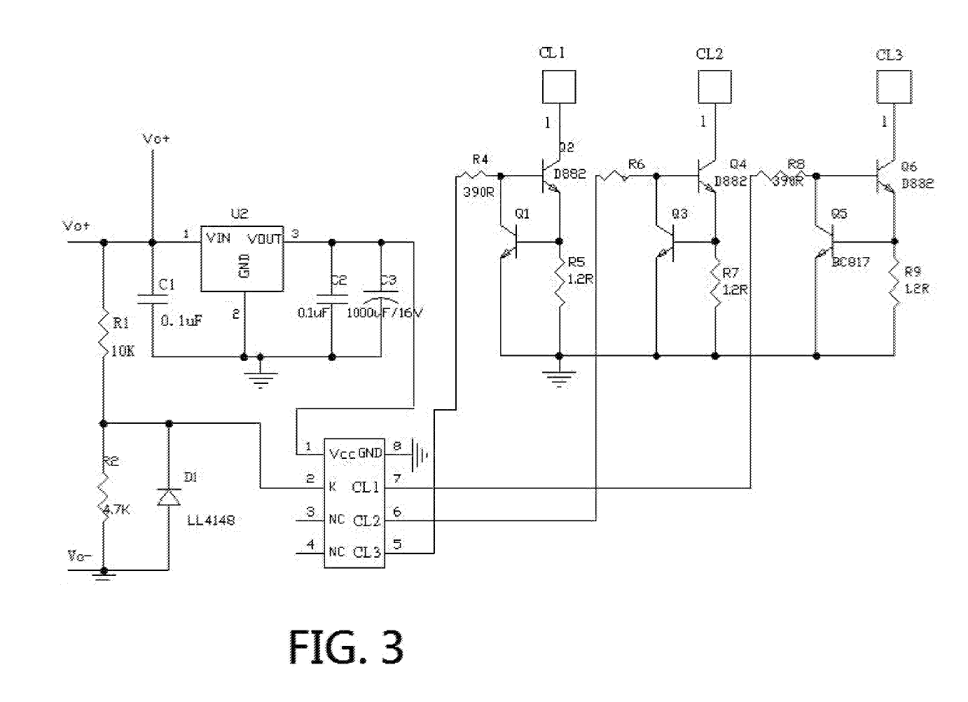

Referring to FIG. 3, it is a schematic diagram of microprocessor circuit in the LED driving device of this invention. As shown in FIG. 3, model of main chip selected for microprocessor 5 is LB308NJ. The main chip enable K (2 pins) externally connects with impulse level judging circuit. The impulse level judging circuit is composed of diode D1, resistance R1 and R2. The diode D1 and resistance R2 connect with R1 in serial after being connected in parallel. Power end Vcc of the main chip connects with positive pole Vo+ of the stabilivolt output circuit by U2. U2 is a 5V three-terminal stabilivolt that will convert voltage generated by driving power into 5V voltage needed for controlling normal operation of IC. A 1000uF electrolytic capacitor C3 is externally connected with IC voltage output VCC for continuous power supply for the chips. AC1 and AC2 are AC connecting terminals (220V AC on-off signal) of power controller. In case of power off, there will be no AC input for AC1 and AC2, and normally there is no current for the whole circuit; the circuit composed of R1, R2 and D1 in FIG. 3 will generate a low level record to enter the chips, and the electrolytic capacitor C3 will continuously supply power for the chips for couples of seconds. When the driving power performs On-Off-On die to an action of the traditional mechanical switch, pin K of the main chip will receive level change signal captured by the level judging circuit, and thus makes a record and performs on-off control on output three pins CL1/CL2/CL3.

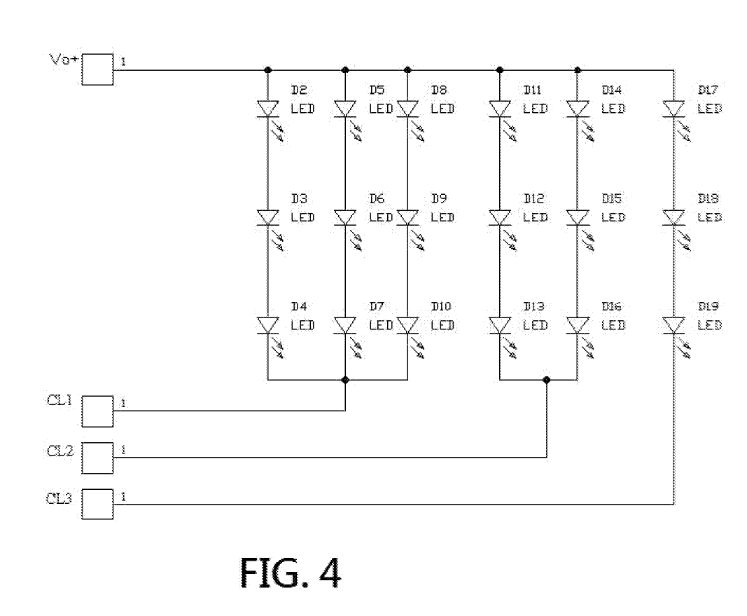

Referring to FIG. 4, three groups of constant current circuit established by twin triode respective control the three lines of LED output are shown. By this way, it comes to that in case of different times of actions by the traditional mechanical switch, effect of one line of multiple lines of LED light emitting will be achieved; and that will finally come to achieve lighting effect at different brightness fulfilled by the traditional mechanical switch.

To sum up, this invention provides an LED device and its control method by using inherent mechanical lamp switch to control brightness of the new type of LED. It is to decide a brightness control by “On” and “Off” of the switch. Different brightness is required at a certain place at various period of time. For example, high brightness is required for work, medium brightness is required for entertainment and low brightness is required before going to bed. The same one LED lamp can offer different luminous fluxes for different demands, and its power consumption also varies (High brightness needed high power consumption, and low brightness causes a low power consumption). By this way, unnecessary power consumption is avoided and benefits an environment protection effect.

While the invention has been described in terms of preferred embodiments, those skilled in the art will recognize that the invention can be practiced with modifications within the spirit and scope of the appended claims.

What is claimed is:

1. An LED driving device, comprising a power converter, a microprocessor and an LED circuit, wherein the power converter comprises impulse transformer and switch control circuit; primary winding at input side of the impulse transformer connects with rectifier filter circuit by the switch control circuit; secondary winding at output side and auxiliary winding connect with power end of the microprocessor by constant voltage control switch; and output end of the microprocessor connects with LED circuit.

2. The LED driving device of claim 1, wherein the rectifier filter circuit comprises preceding capacitor (CX1), a rectifier bridge (BD1), and a primary π-shaped filter circuit, the π-shaped filter circuit is composed of a capacitor (C1), a capacitor (C2) and an inductance (L1).

3. The LED driving device of claim 1, wherein the switch control circuit comprises a main control switch frequency chip, drain electrode end (D) of the main control switch frequency chip connects with surge absorber circuit, the surge absorber circuit is composed of a capacitor (C3), a resistance (R4) and a diode (D4), and two ends of the surge absorber connect with two ends of the impulse transformer and primary winding.

4. The LED driving device of claim 1, wherein the constant voltage control circuit is composed of a stabilivolt output circuit and an auxiliary voltage control circuit; positive pole of the stabilivolt output circuit (Vo+) connects with one end of the secondary winding by an inductance (L3), a rectifier (D6) and an impulse transformer; while the negative pole (Vo−) connects with the other end of secondary winding of the impulse transformer; two ends of the rectifier (D6) connects with filter circuit composed of a resistance (R6) and a capacitor (C8) by parallel connection, two ends of an inductance (L3) connects with the other end of the secondary winding by output filter capacitors (C6 and C7); output end of the rectifier (D6) connects with output end of optical couple (U2) by constant voltage stabilivolt (VR2) and testing resistance (R7), input end (U2) of the optical coupler connects with output end (FB) of the main control switch frequency chip; the auxiliary voltage control circuit is composed of a diode (D5), a capacitor (C4) and a resistance (R5), two ends of the auxiliary winding of the diode (D5), capacitor (C4) impulse transformer connect together to form a loop, one end of the capacitor (C4) connects with bypass (BP) of the main control switch frequency chip by resistance (R5), and the other end is for grounding; and the bypass (BP) of the main control switch frequency chip is in ground connection by capacitor (C5).

5. The LED driving device of claim 4, wherein power end (Vcc) of the microprocessor connects with positive pole (Vo+) of the stabilivolt output circuit by three-terminal stabilizer permitting connection with stabilivolt output circuit by impulse level judging circuit; the impulse level judging circuit is composed of a diode (D1) and resistances (R1 and R2); and the diode (D1) connects with resistance (R1) in serial after connecting with resistance (R2) in parallel.

6. The LED driving device of claim 1, wherein output end of the microprocessor connects with LED circuit by the constant voltage control circuit composed of various groups of twin triode, and each group of the constant control circuit drives an LED circuit.

7. The LED driving device of claim 6, wherein the LED circuit comprises three lines of LED strip including (CL1, CL2 and CL3), and each line of LED strip is composed of various LED strips connected in parallel and serial.

8. A control method of LED driving device of claim 1, characterized in that comprising the following steps:
a) Power converter collects on/off signal of the mechanical switch control lamp; and
b) Microprocessor receives on/off signal from the power converter, and outputs control signal to perform on/off control on LED circuit.

9. The control method of LED driving device of claim 8, characterized in that: one interval between “On” and “Off” of the on/off signal is 0.1-6 second(s), the microprocessor receives on/off signal from the power converter by impulse level judging circuit, the impulse level judging circuit is composed of diode D1, resistance R1 and R2, the diode D1 and resistance R2 connect with resistance R1 in serial after being connected in parallel.
